(19) United States
(12) Patent Application Publication
(10) Pub. No.: US 2004/0017992 A1
(43) Pub. Date: Jan. 29, 2004

(54) Fiber optic link platform

(76) Inventors: Freddie Lin, Redondo Beach, CA (US); Asatur Chakrian, Los Angeles, CA (US); Peter Bumacod, Carson, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/205,803

(22) Filed: Jul. 26, 2002

(51) Int. Cl. G02B 6/00

(52) U.S. Cl. 385/135

(57) ABSTRACT

A fiber optic link platform in a miniature card cage configuration that is designed for installation into conventional floor and wall boxes. The platform of the present invention comprises a plurality of contiguously mounted fiber link communications modules in a ruggedized card cage, as well as a common power supply module that provides the appropriate voltage and current to power all of the remaining modules. The fiber optic link platform typically uses from one to many multimode or single mode optical fibers depending on the communication function and the number of transmit or receive units. The module/card cage configuration permits selections of those communications functions likely to be utilized at each floor box location.

### BACKGROUND OF THE INVENTION

1. Field of the Invention

The present invention relates generally to the field of multimedia signal and data distribution in a confined environment such as floor and/or wall boxes in a hotel, hospital, convention center, theater and the like. More specifically, the present invention relates to an integrated standalone multimedia, minimal perimeter card cage configuration, of data/signal fiber optic-based interfaces which may be mounted in standard floor and wall boxes.

2. Background Art

Floor boxes (and wall boxes) are typically employed in confined environments to provide various forms of hard wired distribution of audio, video and data signals. They permit such distribution of signals while obviating the use of multiple cabling in an inconvenient exposed form that could interfere with personnel traffic, create a safety hazard or simply reduce the aesthetic appeal of the environment. One such typical environment is, for example, a large meeting room or ball room in a hotel. In that environment, strategically located floor boxes permit audio, video and data interface with a remote media control room such as for video presentations, audio amplification, and distribution, computer interconnection, telephone connection, and various bi-direction data as well as conventional and broadband data and video transmissions. Because floor boxes are connected to the media control room by cabling which runs beneath or in the hotel floor, the accessible interior of the meeting room or ball room remains uncluttered and free of cables. One such floor box is disclosed in U.S. Pat. No. 6,265,662.

Typically, such floor boxes are connected to one another and to the media control room by electrical wiring or cables. Because of the large variety of signals that must be accommodated in such floor box systems, the number of separate and distinct cables can become quite large. Moreover, the relatively long distances involved, typically mandate that the respective cables be of relatively heavy gauge to minimize transmission losses that would otherwise produce signal attenuation and reduce signal-to-noise ratios to unacceptable degrees. Consequently, the number and size of cables needed to interconnect a plurality of floor boxes to each other and to a remote media control room can become a difficult and expensive proposition which adds in no small measure to hotel construction costs. Of course, the same concerns would arise in relation to other venues where floor boxes would be beneficial such as convention centers, theaters, hospitals, universities, malls and other commercial centers and the like where multimedia distribution is needed. Furthermore, while reference herein is made primarily to floor boxes, it will be understood that wall box system installations, serving the same purposes as floor box systems, are also contemplated.

It will be seen hereinafter that the present invention offers a remedy to the aforementioned difficulty and expense of having large floor box systems interconnected by conventional electrical cables. That remedy is the implementation of fiber optic interfaces. While the use of fiber optic cables and their connectors in floor boxes is not new (see for example U.S. Pat. No. 5,896,478), the floor boxes that are disclosed for use with fiber optic cables and connectors, are not standard. Their size and shape tend to be unconventional as compared to standard floor boxes in order to accommodate fiber optic cables and connectors. Such special sized and shaped floor boxes tend to be more difficult to use in place of conventional floor boxes in existing structures and they are typically more costly than standard floor boxes. Therefore, the advantages of implementing fiber optic systems in floor boxes is diminished by the need for unconventional floor box sizes and shapes. More importantly, the '478 patent describes only the fiber cabling and connector design which limits multimedia data distribution applications. This is because the multimedia data equipment used must have a fiber optic interface. Unfortunately, most of the popular multimedia data equipment is equipped with electrical interfaces (such as BNC coaxial cable, RJ-45 twisted pair wires, etc.)

There is therefore a need for a fiber optic link system for implementation in standard floor boxes which thereby provides all of the noted advantages over conventional electrical cabling, but without requiring unconventional floor boxes to accommodate such systems. In addition, the fiber optic link system permits the use of electrical multimedia data interfaces, rather than the fiber optic interface.

### SUMMARY OF THE INVENTION

The present invention satisfies the aforementioned need by providing in a preferred embodiment, a fiber optic link platform in a miniature card cage configuration that is designed for installation into conventional floor and wall boxes. Unlike the noted prior art, the unique configuration of the disclosed embodiment does not require a floor box of unconventional size or shape. The platform of the present invention comprises a plurality of contiguously mounted fiber link communications modules in a ruggedized card cage, as well as a common power supply module that provides the appropriate voltage and current to power all of the remaining modules. The fiber optic link platform uses from one to many multimode or single mode optical fibers depending on the communication function and the number of transmit or receive units. The optical fibers are specifically arranged as a fiber ribbon connector with an array of 4, 8, 12, 24 or more fibers tightly packaged together for simplifying installation and maintenance. Such optical fiber ribbon array connector is readily available commercially. The module/card cage configuration permits selections of those communications functions likely to be utilized at each floor box location. By way of illustration, in the presently contemplated best mode of the invention, a typical set of modular functions would include, but is not limited to, an NTSC/PAL video link; a dual-channel baseband audio link; an asynchronous serial data link; a 10/100 Ethernet link; a T1/E1 link; an RGB/synch video link; and a digital video link.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a simplified layout diagram of a typical hotel ball room floor box system;

FIG. 2 is a three-dimensional view of the preferred embodiment adjacent a floor box; and

FIG. 3 is a three-dimensional view of the preferred embodiment installed within a floor box of FIG. 2;

FIG. 4 is an elevational view of a preferred embodiment of the invention;

FIG. 5 is a top view of the embodiment of FIG. 4;

FIG. 6 is a side view of the embodiment of FIG. 4 shown mounted in a standard floor box.

### DETAILED DESCRIPTION OF A PREFERRED EMBODIMENT

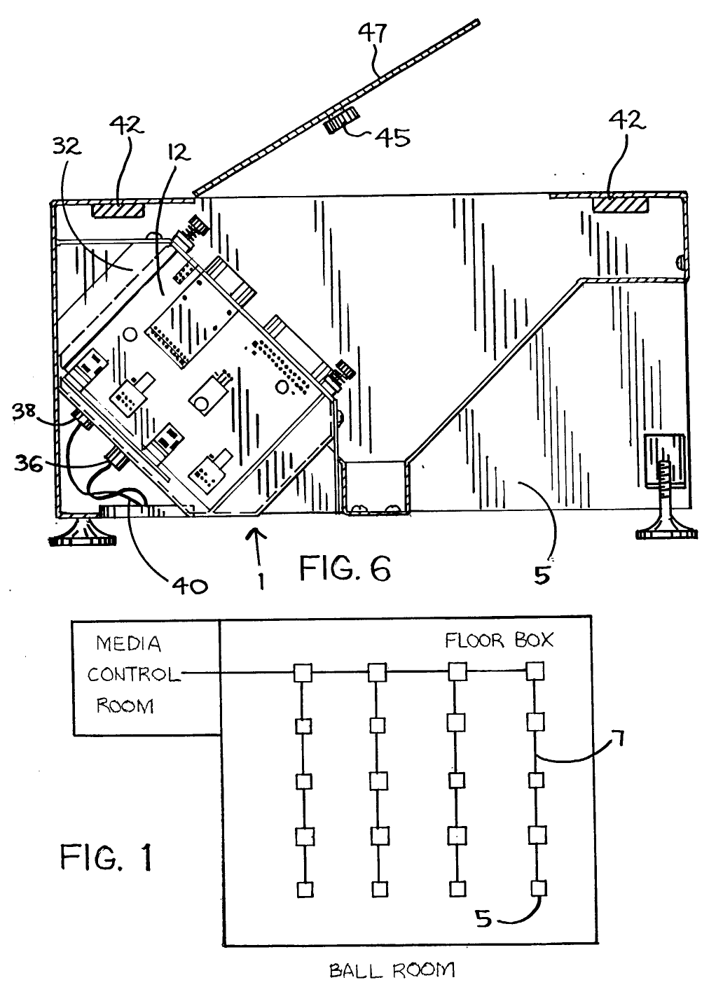

Referring to the accompanying drawings and specifically FIG. 1, it will be seen that a typical hotel ball room 3 has a plurality of floor boxes 5 dispersed at selected locations. The floor boxes 5 are interconnected by cabling 7 and are ultimately connected into a media control room 9. In typical cabling arrangements, each floor box will have its own set of cables to the media control room. It will be understood that the actual number of floor box locations will depend upon the dimensions of the room and the desired spacing between floor boxes to facilitate convenient connections with little or no exposed cabling on the ball room interior. Moreover, it will be more fully appreciated that where each such floor box provides devices for audio, video and data, the cumulative amount of electrical cabling grows substantially until the total size and weight of conduit is extremely large and cumbersome.

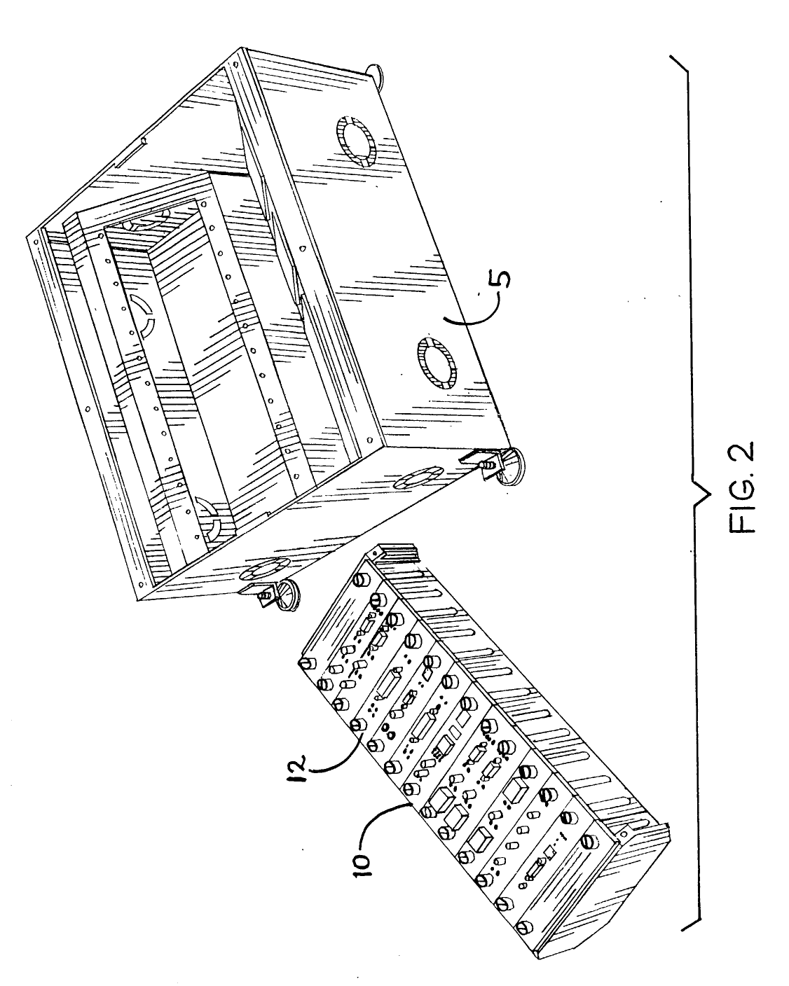

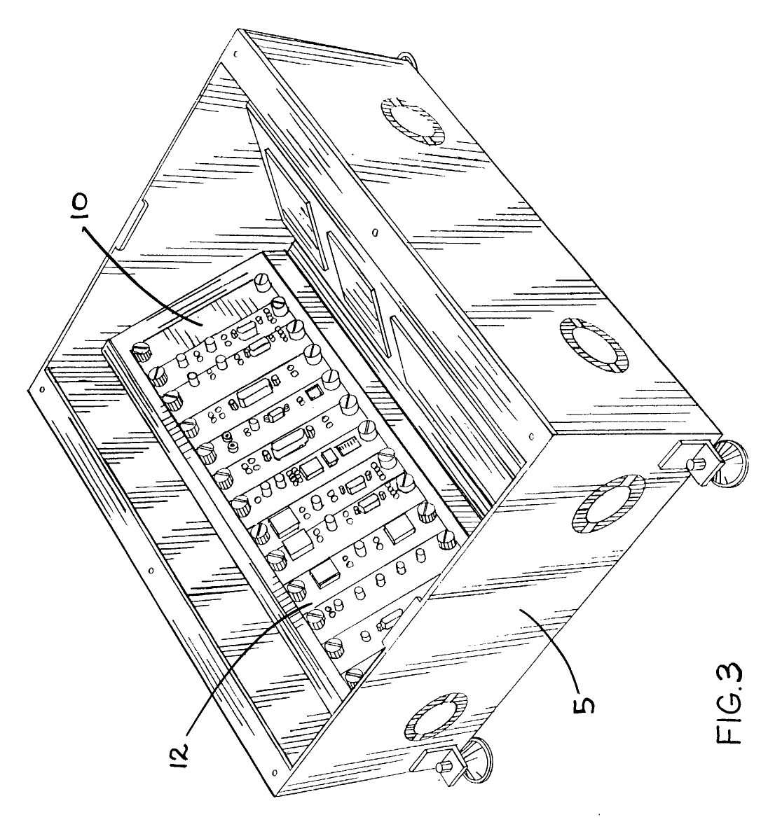

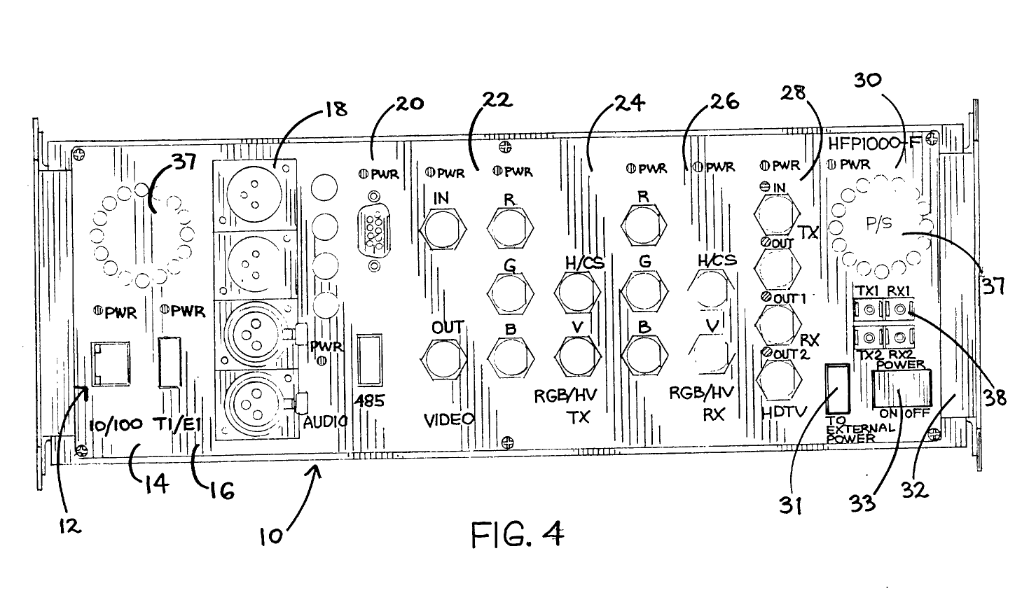

The advantageous alternative provided by the present invention is shown as a preferred embodiment in FIGS. 2 and 3 to which reference is now made. As seen therein, a fiber optic link platform 10 comprises a plurality of selected modules 12 in a floor box assembly 5. In FIG. 4, the front panel of the fiber optic link system 10 is shown. The illustrated embodiment includes, but is not limited to, an Ethernet module 14, a T1/E1 module 16, an audio module 18, a serial data module 20, a video module 22, RGB transmit module 24, RGB received module 26, HDTV module 28 and a commonly connected DC power supply module 30.

There are two contemplated configuration designs for these link modules. One such design is an integrated configuration in which all link modules 12 are packaged as one integral unit such that all the link modules are integrated in a card cage assembly 32. In this configuration, the fiber optic link system 10, together with all link modules 12, is installed as one integral platform. The other design configuration is a plugable arrangement in which the link modules are separately packaged with the card cage assembly 32. Thus the link modules can be individually installed.

The power module 30 accepts preferably a DC power line with common 12, 24, or 48 volts. A power switch 33 is provided for a user to turn on/off the fiber optic link system. Thus, use of the DC power, instead of AC power, simplifies power line distribution/installation complexity and obviates a lengthy electrical safety certification procedure. The power module converts the DC power into appropriate DC voltages, such as 12 or 5 volts for use by the link modules. The power module has a power outlet 31 which provides DC power to external multimedia data equipment, when necessary.

One or more fans 37 are preferably designed into the fiber optic link system to facilitate heat dissipation. Several fiber optic connectors 38 can be designed in the fiber optic link system. This offers fiber optic cable connectivity, in addition to the electrical cable connectivity provided by various link modules.

The link modules 12 provide electrical-to-optical conversion and/or channel multiplexing. The incorporation of electrical-to-optical conversion allows users to leverage on the existing electrical signal interfaces in their own multimedia equipment (such that RJ45 10/100 Ethernet port, BNC video ports from camera and recorder, etc.). The use of the channel multiplexing permits multiple signals on one fiber. Specifically, the Ethernet module 14 provides transmission of a single-channel RJ-45 10/100 Ethernet over single mode or multimode fiber. The T1/E1 module 16 provides transmission of single-channel terminal-block T1 (1.544 Mbps) or E1 (2.048 Mbps) data over single mode or multimode fiber. The audio module 18 provides transmission of a dual-channel baseband stereo audio signal with either RCA or XLR connectors over single mode or multimode fiber. The serial data module 20 provides transmission of multiple channels of asynchronous serial data (such as RS-232, RS422, RS485, etc.) with either a terminal block or a DB-9 connector over one single mode or multimode fiber. The video module 22 provides transmission of single channel BNC NTSC/PAL video over single mode or multimode fiber. The RGB modules 26 transmit or receive BNC RGB/sync video over four single mode or multimode fibers. The digital video module provides transmission of BNC SDI/HDTV video over single mode or multimode fibers. In the illustrated embodiment, each of the aforementioned communications module preferably uses +12 VDC at 1 Amp or less which is provided by the power supply module 30. Each of the modules 12 is a specially configured version of an otherwise commercially available apparatus. For example, Ethernet module 14 is functionally equivalent to a model 6820/6821 Ethernet transceiver offered by Broadata Communications Inc., of Torrance, Calif. The T1/E1 module 16 is comparable to their model 560 T1/E1 data modem. The audio module 18 is comparable to their model 285; serial data module 20 is comparable to their model 510/512/514/515 series asynchronous data modem; the video module 22 is comparable to their model 230; the RGB modules 24, 26 are comparable to their model 4600/4600-D RGB/Sync video system; and the SDI/HDTV module 28 is comparable to their model 1100 digital video/audio transport system. In addition to the above specific electrical-to-optical conversion design, the U.S. Pat. Nos. 4,926,412, 5,026,131, 5,278,687 and 6,272,130 B1 disclose channel multiplexing, which can be either a time division multiplexing or a wavelength division multiplexing. The channel multiplexing can further multiplex and demultiplex signals from multiple link modules into fewer fibers.

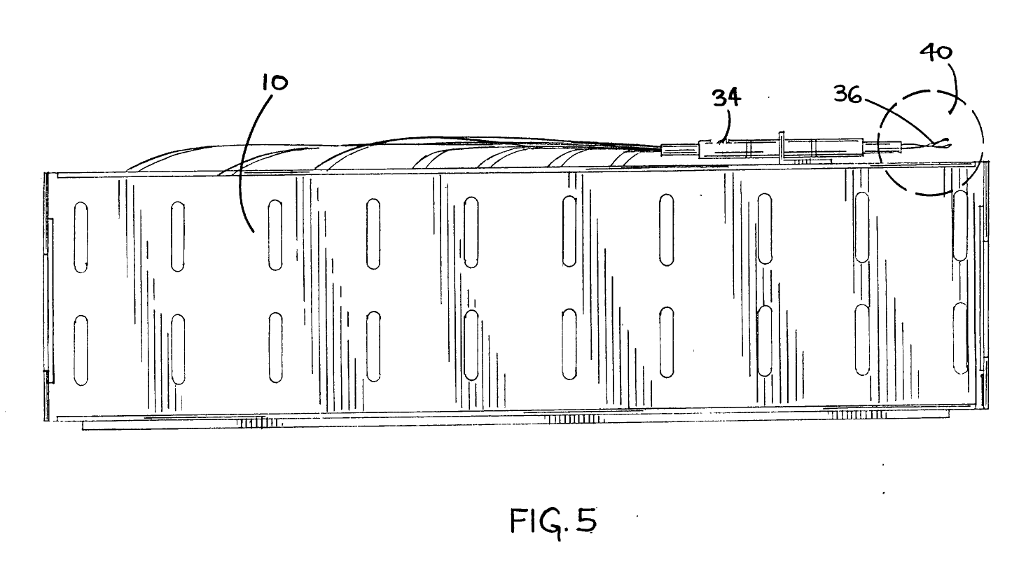

FIG. 5 illustrates the top view of the fiber optic link system 10, in which the fiber optic cables and their connection are shown. The fiber cables originate from one or many link modules connected with fiber cables underneath the floor through a conduit hole 40. Because there may be many fiber connections involved, it is preferable to employ a fiber optical ribbon connector 34 with an array of 4, 8, 12, 24 or more fiber 36 tightly packaged together for simplifying installation and maintenance. Such an optical fiber ribbon array connector is readily available commercially.

FIG. 6 illustrates the top view of the fiber optic link system 10, which is arranged with a 45-degree angle with respect to the floor. This 45-degree arrangement allows a maximum space for the fiber optic system design and yet permits the access of fiber cables 36 and power line 38 from bottom of the floor box 5 through the conduit 40. In addition to the fans 37 packaged inside the fiber optic system, additional fans 42 can also be installed with the floor box 5. The additional fans facilitate added air flow so that heat will not accumulate inside the floor box. It is also preferable to provide a door opening sensor 45 installed in the door of the floor box 47. The sensor triggers the shutdown of the fiber optic link system to prevent overheating when the floor door is closed. Since the fiber optic link system is installed underneath the floor, overheating and water spilling are the concern. The fiber optic link system may therefore also employ temperature and short circuit sensors to shut down the platform in the event of such overheating or a water-induced short.

Having thus disclosed a uniquely configured fiber optic communications link platform that is, in the disclosed embodiment, especially designed to be installed in existing standard floor and wall boxes, it will be understood that numerous variations and additions will now occur to those having the benefit of the teaching herein. Accordingly, the scope of the invention shall be limited only by the appended claims and their equivalents.

We claim:

1. A fiber optic communications link apparatus installed in an accessible box for selective concealment in a floor or wall within an interior of a building; the apparatus comprising:
a plurality of communications modules in a substantially contiguous side-by-side relation, each such module providing a local electrical signal interface and a remote optical signal interface; and
a power supply module contiguous to said communications modules and supplying power to each of said communications modules.

2. The apparatus recited in claim 1 each said communications module having at least one fiber optic cable carrying said remote optical signal interface, each of said fiber optic cables being secured in a common conduit for routing said cables to a remote location.

3. The apparatus recited in claim 1 further comprising:
a card cage receiving said communications modules and said power supply module in said accessible box.

4. The apparatus recited in claim 1 wherein at least one of said communications modules comprises an audio analog signal module.

5. The apparatus recited in claim 1 wherein at least one of said communications modules comprises a video analog signal module.

6. The apparatus recited in claim 1 wherein at least one of said communications modules comprises a serial data modem.

7. The apparatus recited in claim 1 wherein at least one said communications modules comprises a T1/E1 modem.

8. The apparatus recited in claim 1 wherein at least one said communications modules comprises an Ethernet transceiver.

9. The apparatus recited in claim 1 wherein at least one said communications modules comprises an RGB/Sync video device.

10. The apparatus recited in claim 1 wherein at least one said communications modules comprises a digital video/audio transport device.

11. In combination with a box for concealing accessible communications links in a wall or under a floor; a multiple link platform apparatus comprising:
a plurality of communication link modules mechanically configured to be installed within said concealing box, each said module having an optical fiber interface for communication with a remote site and having an electrical interface for communication with local equipment adjacent said box; and
a power supply module for receiving a supply voltage from said remote site and converting said supply voltage to a module voltage for each of said link modules.

12. The apparatus recited in claim 11 each said communications module having at least one fiber optic cable carrying said remote optical signal interface, each of said fiber optic cables being secured in a common conduit for routing said cables to a remote location.

13. The apparatus recited in claim 11 further comprising:
a card cage receiving said communications modules and said power supply module in said accessible box.

14. The apparatus recited in claim 11 wherein at least one of said communications modules comprises an audio analog signal module.

15. The apparatus recited in claim 11 wherein at least one of said communications modules comprises a video analog signal module.

16. The apparatus recited in claim 11 wherein at least one of said communications modules comprises a serial data modem.

17. The apparatus recited in claim 11 wherein at least one said communications modules comprises a T1/E1 modem.

18. The apparatus recited in claim 11 wherein at least one said communications modules comprises an Ethernet transceiver.

19. The apparatus recited in claim 11 wherein at least one said communications modules comprises an RGB/Sync video device.

20. The apparatus recited in claim 11 wherein at least one said communications modules comprises a digital video/audio transport device.
